(19) United States
(12) Patent Application Publication
(10) Pub. No.: US 2023/0127315 A1
(43) Pub. Date: Apr. 27, 2023

(54) WEARABLE EMERGENCY ALERT SYSTEMS AND RELATED METHODS

(71) Applicant: Zoza Inc., Cincinnati, OH (US)

(72) Inventors: Jack Randall, Cincinnati, OH (US); Phillip Horn, Mason, OH (US); Bryce McGuire, Pickerington, OH (US); Sean Kane, Cincinnati, OH (US)

(21) Appl. No.: 17/970,065

(22) Filed: Oct. 20, 2022

Related U.S. Application Data
(60) Provisional application No. 63/270,107, filed on Oct. 21, 2021.

(51) Int. Cl. H04W 4/90; H04W 4/021; H04B 1/3827

(52) U.S. Cl. CPC H04W 4/90; H04W 4/021; H04B 1/385

(57) ABSTRACT

A method of sending an emergency alert from a wearable device. The wearable device is connected to a low-power wide area cellular network and to global positioning services as soon as it is turned on. The wearable device receives inputs from the user and/or from at least one sensor located within the wearable device measuring parameters associated with the status of the user. A determination is then made if an emergency condition has occurred, if so, an emergency alert is transmitted to recipients based on a configured set of emergency contacts. The determining of an emergency condition occurs based on the inputs received through the wearable device or by the inputs received by the at least one sensor corresponding with a set of rules established for determining if an emergency alert should be sent.

### CROSS-REFERENCE TO RELATED APPLICATIONS

The present application claims priority to U.S. Provisional Patent Application No. 63/270,107, filed Oct. 21, 2021, the entirety of which is incorporated herein by reference.

### TECHNICAL FIELD

The examples herein are generally relate to wearable technology. More specifically, the example herein relate to wearable emergency alert systems and methods for using the same.

### BACKGROUND

Wearable devices are ever present in today's society. Users wear them for a plurality of reasons. Some include tracking biometric information, phone calls, listening to music, and to simple telling the time. However, there is currently no known wearable device that has the ability to send an emergency alert to contacts found in the user's phone during an emergency, either sent directly by the user or if the user is unresponsive in an emergency situation, automatically sent by the wearable device.

### SUMMARY

An embodiment provides a method of sending an emergency alert, by a processor of a wearable device comprising: connecting the wearable device to a low-power wide area cellular network and to global positioning services upon activation of the wearable device; receiving one or more inputs from the user on the wearable device and/or from at least one sensor of the wearable device configured to measure one or more parameters; determining if an emergency condition has occurred based on the one or more inputs; and transmitting an emergency alert if the step of determining determines an emergency condition has occurred to one or more emergency contacts based on a configured set of emergency contacts; wherein the determining of an emergency condition occurs based on the one or more inputs received through the wearable device corresponding with a set of rules established for determining if an emergency alert should be sent, or wherein the determining of an emergency condition can occur based on the inputs received by the at least one sensor relating to one or more parameters corresponding with the set of rules.

Another embodiment provides a method as in any embodiment above, further comprising a step of configuring the set of emergency contacts.

Another embodiment provides a method as in any embodiment above, wherein the set of emergency contacts can be placed into separate emergency contact groups.

Another embodiment provides a method as in any embodiment above, wherein the user can designate a primary emergency contact within the set of emergency contacts.

Another embodiment provides a method as in any embodiment above, wherein the wearable device includes a receiver and a transmitter allowing for two-way communication between the user and the emergency contacts of the set of emergency contact.

Another embodiment provides a method as in the embodiment above, further comprising a step of communicating by the user with the one or more emergency contacts of the set of emergency contacts, the communication indicating to the user that the one or more emergency contacts received the transmitted emergency alert.

Another embodiment provides a method as in any embodiment above, wherein the user may utilize geo-fencing to establish a geo-fencing radius around the user to better indicate the position of the user.

Another embodiment provides a method as in any embodiment above, wherein during the step of transmitting, the emergency alert is transmitted first to those one or more emergency contacts that are located within the geo-fencing radius.

Another embodiment provides a method as in any embodiment above, wherein if no emergency contacts of the set of emergency contacts are located within the geo-fencing radius, then the emergency alert is then sent to all emergency contacts.

Another embodiment provides a method as in any embodiment above, wherein the receiving of one or more inputs from the user takes place by the user interacting with at least one button located on the wearable device and wherein the amount of times the user interacts with the at least one button indicates the level of severity of the emergency condition.

Another embodiment provides a method as in any embodiment above, further comprising the step of configuring a geo-fenced safe zone, such that when the wearable device is located within the geo-fenced safe zone, the step of transmitting of an emergency alert cannot take place.

Another embodiment provides a method as in any embodiment above, wherein a location of the user is transmittable to all emergency contacts of the set of emergency contacts.

Another embodiment provides a method as in any embodiment above, wherein if a shorter-range, faster cellular network is connectable to the wearable device, then the wearable device may connect to an utilize the shorter-range, faster cellular network.

Another embodiment provides a wearable device comprising: a housing; a processor contained within the housing; a communication transmitter contained within the housing; a power source contained within the housing; at least one sensor for measuring parameters; at least one button secured to an outside portion of the housing; and a lighting source; wherein the user of the wearable device is able to relay information through the communication transmitter to one or more emergency contacts based on a configured set of emergency contacts through interaction with the at least one button and through said wearable device sending information regarding the parameters measured by the at least one sensor.

Another embodiment provides a wearable device as in any embodiment above, further comprising an attachment mechanism configured to facilitate carriage of the wearable device on the user or on a method of transportation utilized by the user.

Another embodiment provides a wearable device as in any embodiment above, wherein the processor connects the wearable device to a low-power wide area cellular network and to global positioning services as soon as the wearable device is turned on.

Another embodiment provides a wearable device as in any embodiment above, wherein the at least one button is utilized by the user to enter one or more inputs utilized to relay emergency alerts from the user to one or more emergency contacts based on the configured set of emergency contacts.

Another embodiment provides a wearable device as in any embodiment above, further comprising a communication receiver.

Another embodiment provides a wearable device as in any embodiment above, wherein the communication receiver and the communication transmitter allow for two-way communication between the user and the emergency contacts of the set of emergency contacts.

Another embodiment provides a wearable device as in any embodiment above, wherein the lighting source has multiple states corresponding to different actions taken by the user, communications received from the one or more emergency contacts, and different emergency alert levels.

### BRIEF DESCRIPTION OF THE DRAWINGS

The present disclosure will be more readily understood from a detailed description of some example embodiments taken in conjunction with the following figures:

FIG. 1 is an exploded view of a wearable emergency alert device according to an example embodiment.

FIG. 2 depicts an embodiment of a wearable emergency alert device according to an example embodiment.

FIG. 3 depicts an embodiment of a wearable emergency alert device worn on a wrist according to an example embodiment.

FIG. 4 depicts an embodiment of a wearable emergency alert device clipped to a shoe according to an example embodiment.

FIG. 5 depicts a method of detecting a fall according to an example embodiment.

FIG. 6 depicts a method of detecting a fall according to an example embodiment.

FIG. 7A depicts a method of setting up and using a wearable emergency alert device according to an example embodiment.

FIG. 7B depicts further steps of the method of FIG. 7A.

FIG. 8 depicts a method of setting up and using a wearable emergency alert device according to an example embodiment.

FIG. 9 depicts a method of alerting an emergency contact of a detected fall according to an example embodiment.

FIG. 10 depicts an example user interface configuration for an application according to various embodiments.

FIG. 11 depicts an example user interface configuration for an application according to various embodiments

FIG. 12 depicts an example user interface configuration for an application according to various embodiments

FIG. 13 depicts an example user interface configuration for an application according to various embodiments

FIG. 14 depicts an example user interface configuration for an application according to various embodiments

FIG. 15 depicts an example user interface configuration for an application according to various embodiments

FIG. 16 depicts an example user interface configuration for an application according to various embodiments

FIG. 17 depicts an example user interface configuration for an application according to various embodiments

FIG. 18 depicts example digital features of an application according to various embodiments.

### DETAILED DESCRIPTION OF ILLUSTRATIVE EMBODIMENTS

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of apparatuses, systems, and methods for a portable SOS device that alerts contacts found in the user's phone during an emergency. In an example embodiment, the user may choose to send an alert to a contact to check in or to request assistance during an emergency. In some embodiments, the device is configured to detect a fall and, if the user is unresponsive, automatically sends an alert to the emergency contact(s). In some embodiments, the emergency contact has access to the user's location. The system may include different types of alerts for varying levels of emergency.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example embodiments described herein can provide a wearable and durable device that provides security and confidence with a compact, unobtrusive, and affordable design. As described further below, the user can alert predefined emergency contact(s) with their current GPS location and a specified emergency level. The emergency contact(s) can track the user's location for the duration of an activity (e.g., training, a hike, etc.). Because a user may be in areas with poor reception for more advanced networks (e.g., 4G), a secure long-range connection is provided by using a low-power, wide area cellular network (e.g., LTE-M). In some embodiments, the device is configured to detect a fall using accelerometer and gyroscope data. GPS data may additionally be used to detect a fall. An example application for the wearable device include use by an athlete training in a remote or potentially unsafe location. Another example use is for a parent who wants to track the location of a child and provide them with ability to request help at the press of a button.

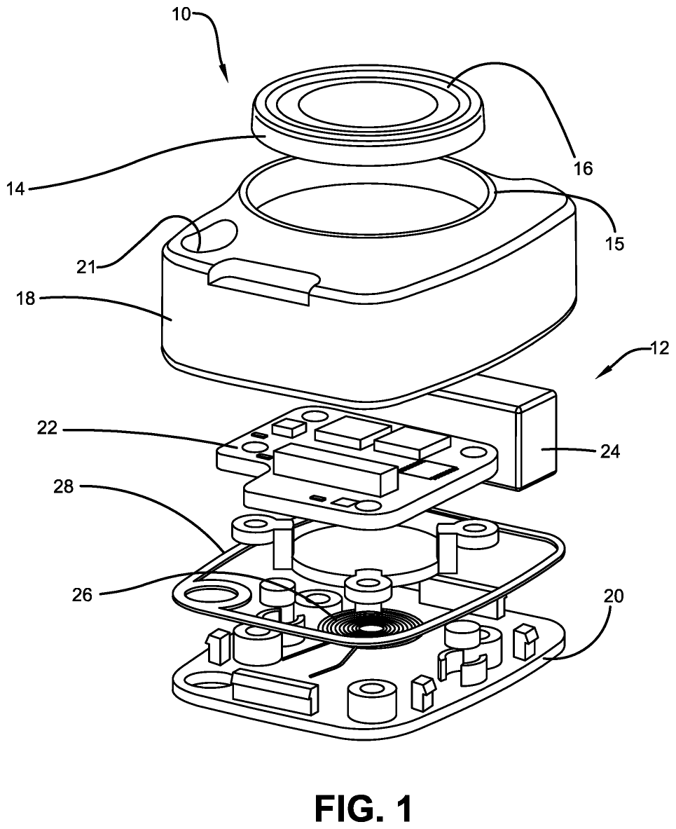

Referring now to FIG. 1, in an embodiment, a wearable device 10 includes a housing 12, at least one button 14, and a light source 16. Though not shown, the device 10 may include a buzzer (e.g., to provide haptic feedback) or an audio source such that device 10 may be configured to provide an audible or tactile alert. The housing 12 may include a housing body 18 and a base 20. The housing 12 may be, for example, molded plastic. The material of the housing 12 may be, without limitation, acrylonitrile butadiene styrene. The outer surface of the housing 12 may be textured to enhance grip. The housing 12 may be coated in a waterproof material, such as epoxy, acrylic, polyurethane, or a combination thereof. In an embodiment, the housing 12 may be waterproof or water-resistant based on a standard, such as IP67. The button 14 may be, for example, a silicon molded button, such as a hybrid membrane switch.

The housing 12 may contain electronic components such as a circuit board (e.g., PCBA 22) and a power source (e.g., a battery 24). In an embodiment, the PCBA 22 and the battery 24 are oriented next to each other, rather than stacked vertically, to provide a smaller device profile. The circuit board 22 may be electronically coupled to a long-range network connection unit (e.g., TruPhone Nano SIM (LTE-Network)), a cellular/GPS microcontroller (e.g., NRF9160-SICA-R), a wireless network connection unit (e.g., Bluetooth/Wi-Fi Module (NRF52820-QDAA-R)), and a virtual antenna (FR01-S4-224). A high latency (reduced data transmission speed) network (e.g., LTE-M) provides increased coverage compared to the low latency of a network such as LTE 4G. The device 10 may also include an accelerometer (e.g., LIS2DE12TR) and a gyroscope in connection with the circuit board. The power source 24 may be chargeable (e.g., capacitive or inductive).

In an embodiment wherein the power source 24 is chargeable, the device 10 may include a copper coil 26 adjacent the power source 24. In one or more embodiments, the device 10 may also include a rubber gasket 28 that will provide a waterproof seal when all the interior components are fitted together within the housing 12. In an embodiment, the device 10 may include a connection for a charging cord or may be rechargeable using solar energy or through motion. The device 10 may also include one or more magnets that allows the device 10 to be magnetically secured to a dock or other surface.

The light source 16 may include one or more lights, such as a red, green, and blue light producing LED. The light source 16 may be configured to produce lights of different colors, such as green, red, yellow, blue, etc. The light source 16 may be configured to provide steady light, light that flashes in a pattern (e.g., blinks), or light that spirals or swirls around the light source 16. The light source 16 may have multiple states (e.g., solid green light, blinking blue light) corresponding to different actions taken by the user or different alert levels as described further below). The light source 16 may be integrated into the button 14. In an embodiment, the device 10 may be secured in a protective case (not shown).

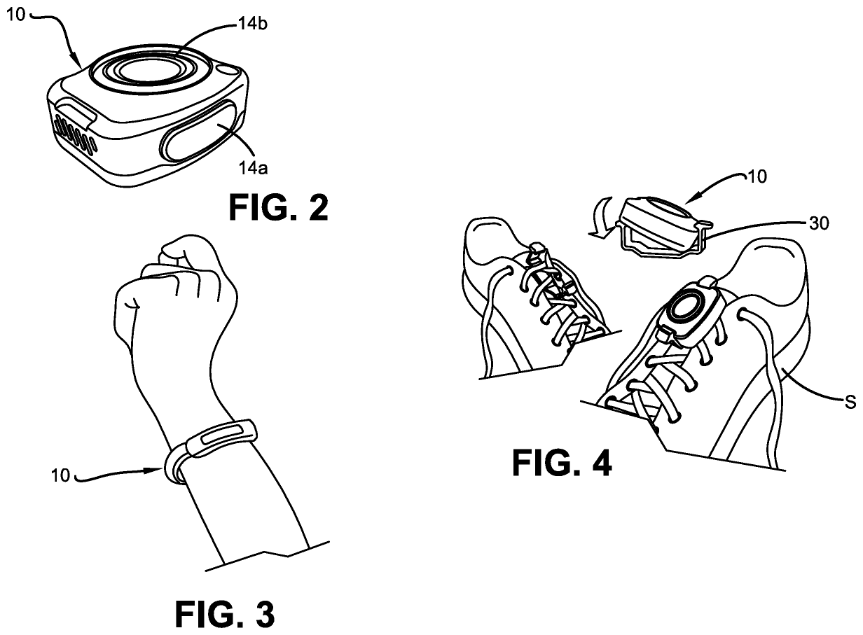

As shown in FIG. 2, the shape and size of the device 10 may vary. The device 10 may include more than one button 14. Where there is more than one button 14, one of the buttons 14a may be configured to turn the device 10 on and off, while the other button 14b is used for communication as discussed further below. Multiple buttons may allow for additional alert sequences or emergency levels. The button(s) 14 may be positioned on a top of the device, the side of the device, or both. Having one button 14 compared to multiple buttons 14a and 14b may improve the ease of use (less thought about which button to use for which function) and allow the device 10 to be smaller. The device 10 may be configured to reduce accidental pressing of the button(s) 14. For example, the button(s) 14 may be recessed in the housing 12. As shown in FIG. 1, the housing 12 may include a raised rim 15 extending above the button 14.

In various embodiments, the device 10 may have modular attachment features. For example, the device 10 may include a fastener, such as a keychain, which will attach to device 10 through the keyhole 21 as shown in FIG. 1. The device 10 may be configured to be worn on the user's wrist as shown in FIG. 3. Alternatively or additionally, the device 10 may be removably coupled to a clip, which can in turn be secured to the user or another object. FIG. 4 shows device 10 attached to a shoe clip 30, which is held to a shoe S by shoelaces. Device 10 may be threaded to the shoe clip 30 or snapped into the shoe clip 30. The clip 30 may be made of plastic, such as polypropylene, that retains the shape after repeated use of placing and removing the device 10. In various embodiments, device 10 may be coupled to an existing watchband or coupled to a piece of equipment (e.g., clipped to a bicycle handlebar). Device 10 may be configured to determine whether or not it is secured to a clip, such as clip 30.

In one or more embodiments, device 10 has multiple states that correspond to different alert levels. In a default state, for example, light source 16 may be off. If a user wants to check in with an emergency contact, the user may press button 14 once, causing light source 16 to display a first color (e.g., green). If the user experiences an emergency situation, the user may press button 14 to inform the emergency contact of the emergency situation. There may be different levels of emergency situations. For example, the user may press button 14 twice for a level 1 emergency or three times for a level 2 emergency, causing light source 16 to display a second color (e.g., yellow) or a third color (e.g., red), respectively. The emergency contact could then either intervene (e.g., in a Level 1 emergency) or contact emergency responders (e.g., call 911). As described further below, the emergency contact may respond to the request. In an embodiment, light source 16 may blink repeatedly until the emergency contact responds to the alert. The two-way communication allows the user to know when an emergency contact has responded. An illustrative use of the example three alert levels follows. If the user has taken longer than expected to complete the activity, the user may check in to let someone know they have not encountered any issues. If the user twists an ankle and cannot return home by themselves, the user may initiate a level 1 emergency request to have the emergency contact come help them. If the user suffers a hard fall while riding a bicycle by themselves, they may initiate a level 2 emergency request to have the emergency contact call 911 for assistance.

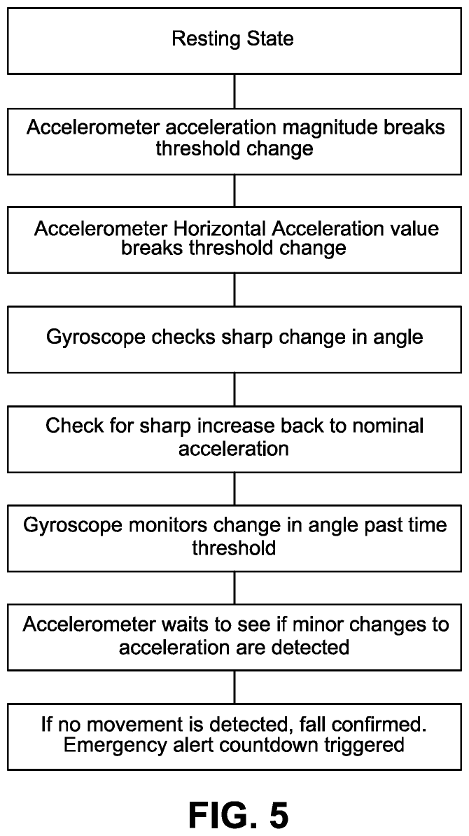

As described above, the device may be configured to detect when a fall occurs. With reference to FIG. 5, in an embodiment, an algorithm uses information from both an accelerometer and a gyroscope in the device 10 to detect falls. The algorithm may analyze whether a change of 50% or higher in the operating acceleration occurs to determine if an object (e.g., the user) has fallen. Due to external forces (e.g., driving in a car or gaining altitude in a plane), the algorithm analyzes at all three acceleration axes individually and the magnitude of the acceleration vector. In doing so, the algorithm will be able to determine if the object is falling or, for example, merely in an accelerating car. In some embodiments, the algorithm analyzes data after a fall occurred to determine whether the object (e.g., a person) is immobile. For example, the algorithm may determine whether the acceleration vector returns to a constant 9.8 m/s² or not, as well as if the gyroscope provides data indicating the user got back up. The threshold for determining that a fall occurred may be a range of force, such as between 1 and 10 g. The gyroscope measurements may be used to determine a change in angle of about 80-100 degrees when the accelerometer acceleration vectors break threshold values, as well as change in angle after the fall event is detected, to ensure an emergency alert is not unwarrantedly sent.

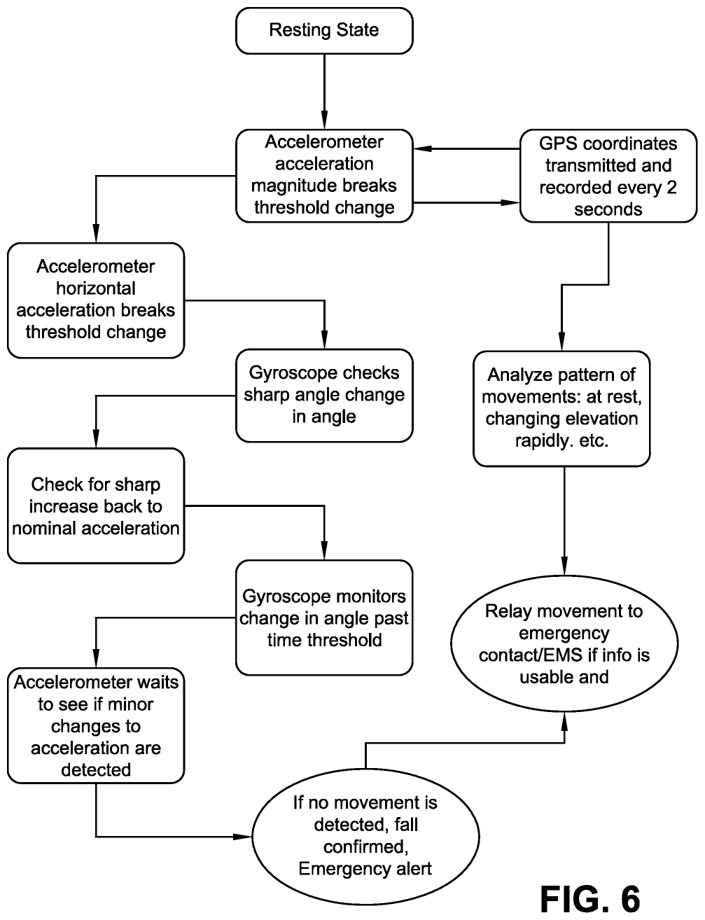

With reference to FIG. 6, in some embodiments, the system is configured to track and store GPS information. The GPS information may be used to characterize a fall event. The GPS information may be conveyed to the user's emergency contact(s) or emergency services when falls are detected.

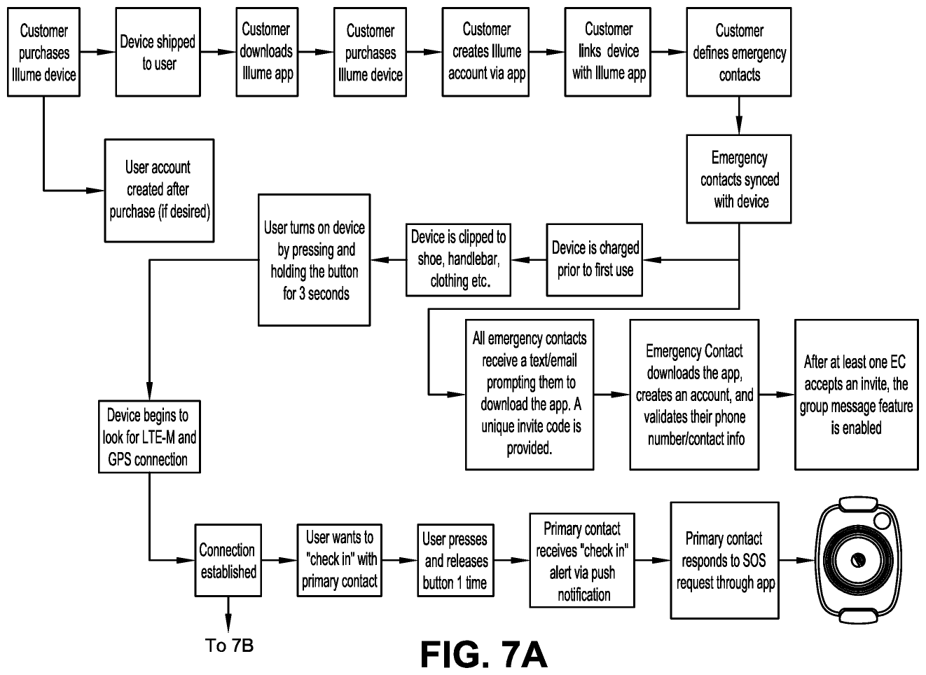

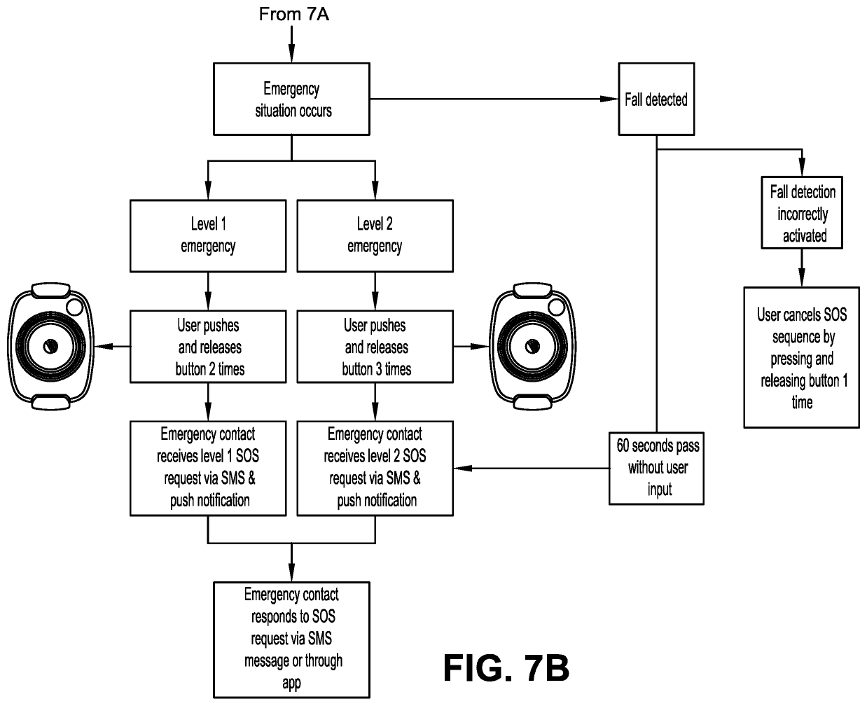

Referring now to FIGS. 7A and 7B, according to an embodiment, a method of setting up and using a device 10 is described. A customer purchases device 10, which is then shipped to the customer. The user may create the account after purchase if desired. The user downloads the mobile application and creates an account or logs into an existing account. The customer can link device 10 with the application (e.g., using Bluetooth). The customer selects a service plan and enters payment information. The user can then add emergency contact(s) within the mobile application. In some example embodiments, the user can designate a “primary” emergency contact, someone that can be notified above all other emergency contacts. The emergency contacts can be grouped (e.g., different training groups, groups that will receive an SOS request based on different activities or locations, etc.). The emergency contacts are then synced with device 10. When an emergency contact is added, the contact receives a notification (e.g., text, email, etc.) prompting them to download the application. A unique invitation code is provided. The emergency contact downloads the application, creates an account if needed, and validates their phone number or other contact information. After at least one emergency contact accepts an invitation, the group message feature is enabled.

Still referring to FIGS. 7A and 7B, to use device 10, device 10 is charged prior to first use and then attached to the user or other object (e.g., clipped to a shoe, handlebar, or clothing, etc.). Before or after attaching device 10, the user turns on device 10 by pressing and holding button 14 for a predefined period of time (e.g., 3 seconds). The device 10 searches for an LTE-M and GPS connection, and the connection is established. The light source 16 may provide an indication (e.g., flash blue) while searching for the LTE-M network and GPS signal. The light source 16 may then provide an indication that the LTE-M and GPS connectivity has been acquired (e.g., turn solid blue). With most example embodiments, device 10 connects to LTE-M and GPS as soon as device 10 is turned on, device 10 does not wait for an emergency situation to occur prior to connecting to LTE-M and GPS. Time is of the essence in an emergency situation, therefore, by automatically connecting to LTE-M and GPS, device 10 can transmit data immediately when an emergency situation occurs. This feature also allows for emergency contacts to monitor the users location throughout the duration of activity for which device 10 is being worn by the user. This feature additionally allows for the location of the user to be determined by GPS prior to an emergency situation occurring, instead of waiting for an emergency situation to occur before tracking the location of the user.

The user may then want to “check in” with the primary contact in a non-emergency situation. To do so, the user presses and releases button 14 one time. The primary contact receives “check in” alert via push notification. The primary contact can then respond to the request through the application. In some embodiments, device 10 may be configured to alert the user when the primary contact responds thus providing two-way communication.

With further reference to FIGS. 7A and 7B, in some embodiments, an emergency situation may occur when a fall is detected. In an embodiment, the system may determine that the fall detection was incorrectly activated. If a fall was erroneously detected, the user may cancel the SOS sequence by pressing and releasing button 14 one time. If a predetermined period of time (e.g., 60 seconds) passes after the detection of the fall without user input, then the emergency contact(s) receive a Level 2 SOS request via SMS & push notification. In some embodiments, there may be an emergency situation even if a fall has not been detected. If there is a Level 1 emergency, the user presses and releases button 14 two times. The emergency contact(s) then receive a Level 1 SOS request via SMS & push notification. If there is a Level 2 emergency, the user presses and releases button 14 three times. The emergency contact(s) then receive a Level 2 SOS request via SMS & push notification. When an emergency contact(s) receives any SOS request, the emergency contact(s) can respond to the SOS request via SMS message or through the application. The device 10 may indicate to the user that the response was received (e.g., using visual feedback, haptic feedback, etc.). Through this two-way communication, the user is then aware that an emergency contact received and responded to the request.

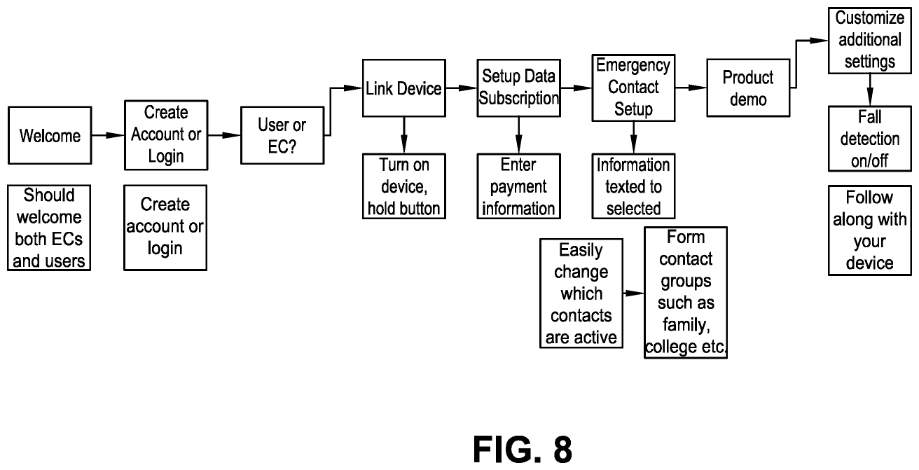

FIG. 8 shows another example method of setting up and using device 10. In an embodiment, the device may allow the user to predefine a maximum number of emergency contacts (e.g., up to 10 emergency contacts). The user defines the emergency contacts within the mobile application, which is then synced with device 10 via Bluetooth. The application allows the user to define emergency contact groups (e.g., college friends near school, family when at home, etc.). Device 10 may be turned on by pressing and holding button 14 for a predetermined period of time (e.g., 3 seconds).

In an embodiment, if the power source 24 of device 10 is low, a push notification is sent to the user through the mobile application requesting that device 10 be charged. In other embodiments, the light source 16 could continually flash to indicate that the power source 24 needs a charge. For example, push notifications may be sent when the charge in the power source 24 depletes to 20%, to 10%, and just prior to the power source 24 dying.

The user may send the emergency contacts a notification when a new activity begins (e.g., beginning a hike or training exercise). As described above, different alerts or SOS requests may be initiated using different sequences on button 14. The light source 16 may inform the user of the message status (e.g., requesting message, sending, sent). In situations where the user is unable to press button 14, device 10 is configured to detect a fall and initiate an alert. Device 10 may indicate that a fall was detected (e.g., the light source 16 flashing red, through haptic feedback, audio feedback, etc.). The user can then cancel the alert initiated by the fall detection by pressing and releasing button 14 within a specified timeframe (e.g., within 60 seconds). When an alert or SOS request is initiated, device 10 is configured to send the GPS coordinates at the time of the request to the emergency contact(s) over the LTE-M network. The emergency contact may receive one or both of a push notification through the application and an SMS message dictating the user's level of emergency and GPS location. The sending of GPS coordinates at the time a request is sent to an emergency contact, and not after a request is sent, is a distinction between these example embodiments and known prior art methods.

In an embodiment, geo-fencing may be used to send an SOS request to emergency contacts closest to the user. The application may allow geo-fencing to be activated or deactivated, and the user may be able to set the geo-fencing radius. In addition to alerting emergency contacts, in an embodiment, a call center able to handle emergency requests may be notified. Emergency contacts can track the user's location through the application by requesting periodic updates (e.g., every 60 seconds), even if an emergency alert has not be triggered by the user. Once an emergency contact is alerted of an SOS request, they can respond allowing the user to know that help is on the way. If more than one emergency contact is alerted, push notifications and/or SMS messages are sent to those contacts who did not respond to the request so they know the situation is being handled. The light source 16 may indicate (e.g., by flashing an LED sequence) that an emergency contact responded and help is on the way. Device 10, combined with the mobile application, will not end an emergency event until the emergency contacts that were notified of the event and/or the user has denoted the emergency event as “resolved” through the mobile application. This will ensure that the emergency event is not dismissed just by a change in the measurable of device 10.

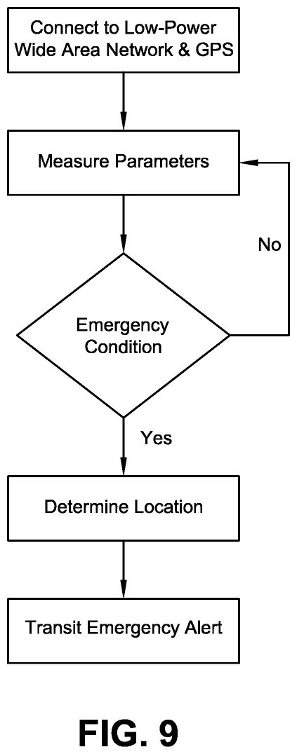

FIG. 9 provides an example method by which device 10 alerts an emergency contact to an emergency situation.

In some embodiments, device 10 may be configured to detect an impact event other than a fall (e.g., the user being hit by something). Device 10 may be configured to detect dramatic changes in the speed or acceleration of device 10. The threshold for determining an impact event occurrence may be higher than the threshold for determining that a fall occurred. For example, the threshold for detecting an impact event occurring may be 40 g. After an impact event is detected, device 10 may proceed according to the example methods described above after a fall is detected.

It will be appreciated that device 10 may include additional features. In an embodiment, device 10 may be configured to rate limit the number of requests in a defined time period. For example, if ten requests are requested in the span of one minute, only one request will be sent to the relevant emergency contacts. In an embodiment, device 10 may provide feedback to let the user know that button 14 was pressed and a request is about to be sent (e.g., visual, audible, or tactile/vibrating indication). Device 10 may be configured to allow the user to cancel a request after button 14 is pressed. For example, there may be a time delay between the user initiating a request and sending the request that gives the user time to cancel the request.

In an embodiment, the user may be able to define a “safe” or request-free location. For example, the user may be able to designate a geo-fenced location around the user's home that prevents any requests from being sent while the device 10 is within that location. This will help prevent the unwanted sending of emergency event requests by button 14 accidently being pressed by the user or other members of the user's household.

The user may be able to predefine a route for an activity and, if the user deviates from the predefined route by a specified distance, an alert is initiated to the primary emergency contact. The system, meaning device 10 and the mobile application, may be configured to track the route during an activity. The user may be able to add comments or markers on the tracked route in the mobile application. In an embodiment, device 10 may include a tab that, when pulled from the device 10, triggers an emergency request. In an embodiment where the user is connected to a shorter-range, faster network (e.g., LTE 4G) and a longer-range, slower network (e.g., LTE-M), device 10 may send a request over the faster network or over both networks.

In an embodiment, device 10 may be configured to communicate with a separate sensor. For example, device 10 may be configured to communicate with a radar sensor coupled to the user or a piece of equipment. In an embodiment, the radar sensor may be coupled to the back of a bicycle, and device 10 may be configured to alert the user if an object (e.g., a car) approaches within a certain distance. In another embodiment, device 10 may be configured to alert the user if the separate sensor moves out of range of device 10 (e.g., if the user dropped the piece of equipment without realizing it).

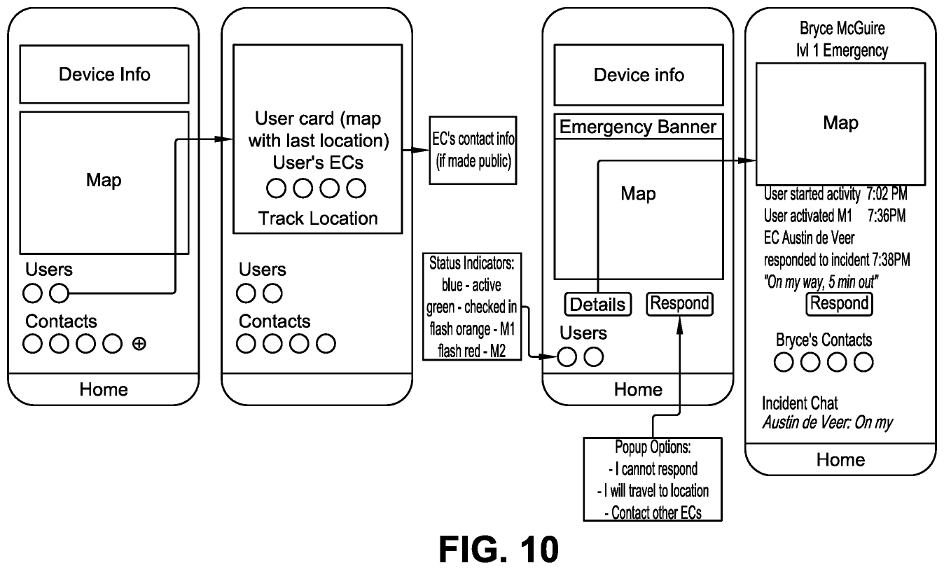

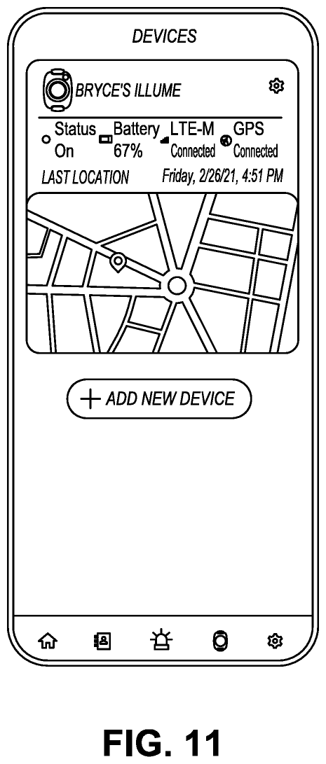

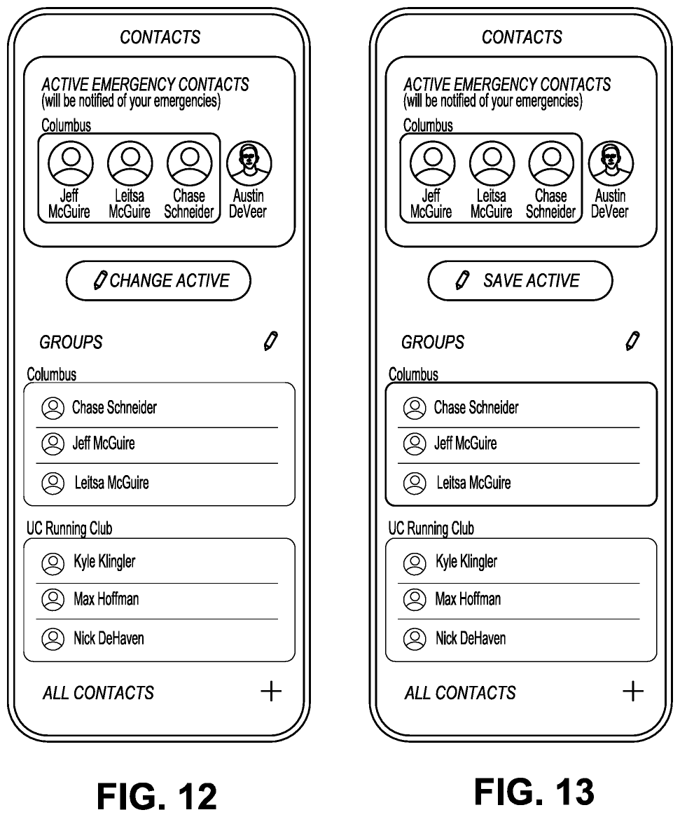

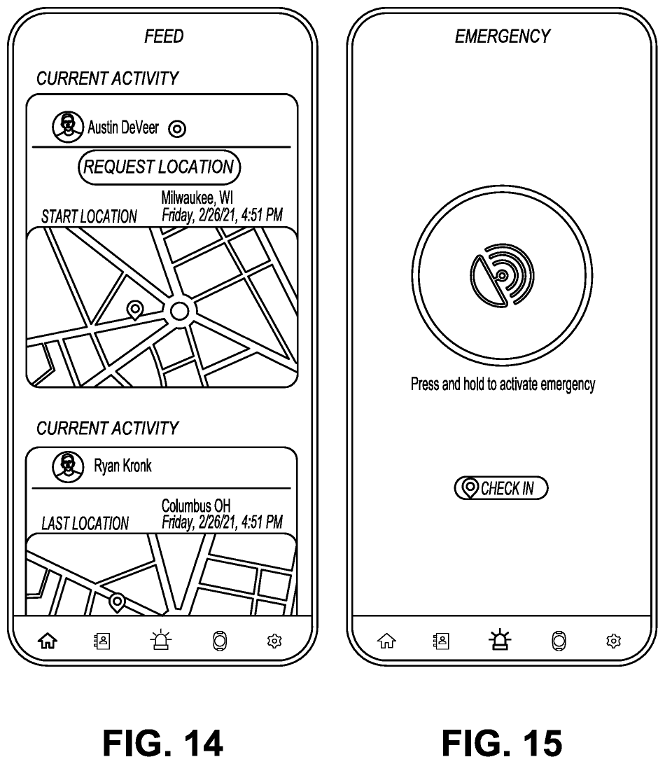

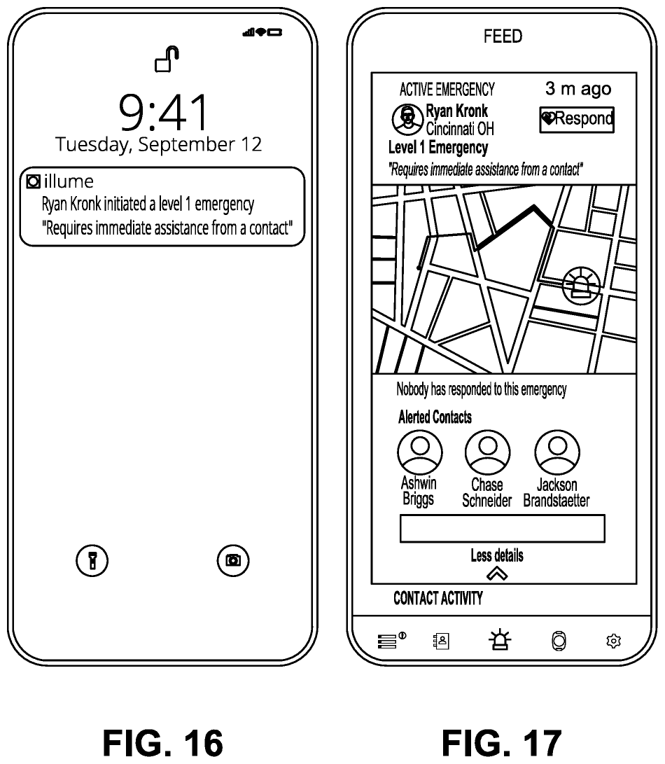

FIGS. 10-17 depict example user interface configurations for the mobile application according to various embodiments.

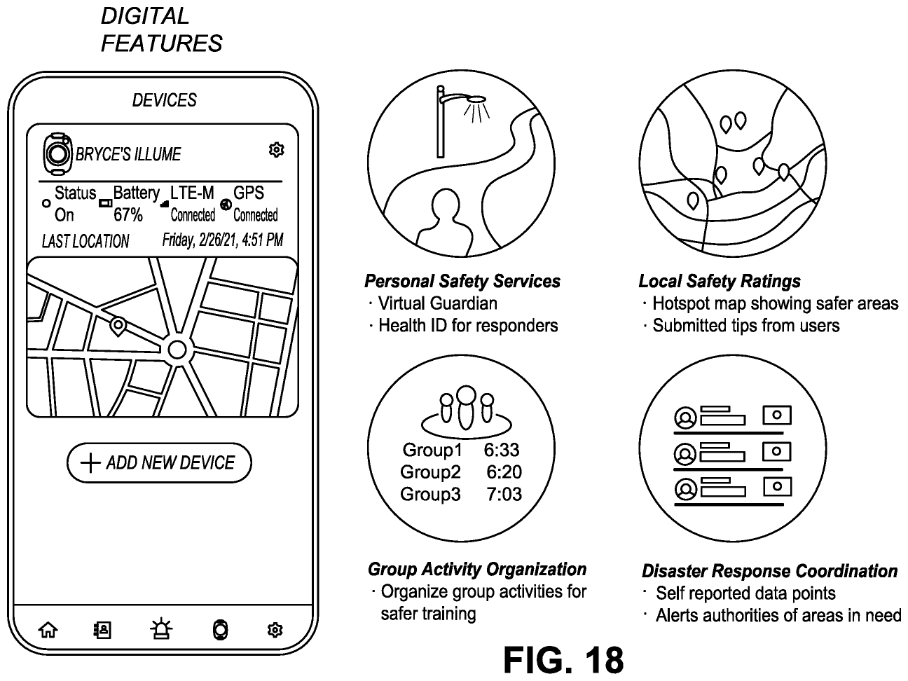

As shown in FIG. 18, in some embodiments, the mobile application may provide additional features, such as personal safety services, local safety ratings, group activity organization, or disaster response coordination. Personal safety services may include, for example, a virtual guardian feature while traveling, or a health ID for responders. Local safety ratings may include, for example, a hotspot map showing the relative safety of different areas or tips submitted by users (e.g., a dangerous spot in a race location). The application may allow for group activities to be organized that increase the safety for those participating. Disaster response may be coordinated through the application, for example, using self-reported data points and alerts to authorities of areas in need. In some embodiments, the device may be used as a “finder” for other items (e.g., keys, wallet). Device 10 may produce an audible alert when activated on the application.

There may be situations where the user becomes incapacitated. Device 10 may be, in an embodiment, engraved with contact information for the user's primary emergency contact. In an embodiment, device 10 may be configured to automatically transmit information (e.g., identifying information, emergency contact information, etc.) to a nearby device, such as a bystander's phone. For example, the emergency contact information may be sent using a near field communication transmitter.

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi-temporary.

A “computer,” “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments. The memory can also include any means for storing software, including a hard disk, an optical disk, floppy disk, ROM (read only memory), RAM (random access memory), PROM (programmable ROM), EEPROM (electrically erasable PROM) and/or other computer-readable media. Non-transitory computer-readable media, as used herein, comprises all computer-readable media except for a transitory, propagating signals.

In various embodiments disclosed herein, a single component can be replaced by multiple components and multiple components can be replaced by a single component to perform a given function or functions. Except where such substitution would not be operative, such substitution is within the intended scope of the embodiments.

Some of the figures include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

Having shown and described various versions in the present disclosure, further adaptations of the methods and systems described herein may be accomplished by appropriate modifications by one of ordinary skill in the art without departing from the scope of the present disclosure. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present disclosure should be considered in terms of the following claims and is understood not to be limited to the details of structure and operation shown and described in the specification and drawings.

What is claimed is:

1. A method of sending an emergency alert, by a processor of a wearable device comprising:
connecting the wearable device to a low-power wide area cellular network and to global positioning services upon activation of the wearable device;
receiving one or more inputs from the user on the wearable device and/or from at least one sensor of the wearable device configured to measure one or more parameters;
determining if an emergency condition has occurred based on the one or more inputs; and
transmitting an emergency alert if the step of determining determines an emergency condition has occurred to one or more emergency contacts based on a configured set of emergency contacts;
wherein the determining of an emergency condition occurs based on the one or more inputs received through the wearable device corresponding with a set of rules established for determining if an emergency alert should be sent, or wherein the determining of an emergency condition can occur based on the inputs received by the at least one sensor relating to one or more parameters corresponding with the set of rules.

2. The method of claim 1, further comprising a step of configuring the set of emergency contacts.

3. The method of claim 2, wherein the set of emergency contacts can be placed into separate emergency contact groups.

4. The method of claim 2, wherein the user can designate a primary emergency contact within the set of emergency contacts.

5. The method of claim 1, wherein the wearable device includes a receiver and a transmitter allowing for two-way communication between the user and the emergency contacts of the set of emergency contact.

6. The method of claim 5, further comprising a step of communicating by the user with the one or more emergency contacts of the set of emergency contacts, the communication indicating to the user that the one or more emergency contacts received the transmitted emergency alert.

7. The method of claim 1, wherein the user may utilize geo-fencing to establish a geo-fencing radius around the user to better indicate the position of the user.

8. The method of claim 7, wherein during the step of transmitting, the emergency alert is transmitted first to those one or more emergency contacts that are located within the geo-fencing radius.

9. The method of claim 8, wherein if no emergency contacts of the set of emergency contacts are located within the geo-fencing radius, then the emergency alert is then sent to all emergency contacts.

10. The method of claim 1, wherein the receiving of one or more inputs from the user takes place by the user interacting with at least one button located on the wearable device and wherein the amount of times the user interacts with the at least one button indicates the level of severity of the emergency condition.

11. The method of claim 1, further comprising the step of configuring a geo-fenced safe zone, such that when the wearable device is located within the geo-fenced safe zone, the step of transmitting of an emergency alert cannot take place.

12. The method of claim 1, wherein a location of the user is transmittable to all emergency contacts of the set of emergency contacts.

13. The method of claim 1, wherein if a shorter-range, faster cellular network is connectable to the wearable device, then the wearable device may connect to an utilize the shorter-range, faster cellular network.

14. A wearable device, comprising:
a housing;
a processor contained within the housing;
a communication transmitter contained within the housing;
a power source contained within the housing;
at least one sensor for measuring parameters;
at least one button secured to an outside portion of the housing; and
a lighting source;
wherein the user of the wearable device is able to relay information through the communication transmitter to one or more emergency contacts based on a configured set of emergency contacts through interaction with the at least one button and through said wearable device sending information regarding the parameters measured by the at least one sensor.

15. The wearable device of claim 14, further comprising an attachment mechanism configured to facilitate carriage of the wearable device on the user or on a method of transportation utilized by the user.

16. The wearable device of claim 14, wherein the processor connects the wearable device to a low-power wide area cellular network and to global positioning services as soon as the wearable device is turned on.

17. The wearable device of claim 14, wherein the at least one button is utilized by the user to enter one or more inputs utilized to relay emergency alerts from the user to one or more emergency contacts based on the configured set of emergency contacts.

18. The wearable device of claim 14, further comprising a communication receiver.

19. The wearable device of claim 18, wherein the communication receiver and the communication transmitter allow for two-way communication between the user and the emergency contacts of the set of emergency contacts.

20. The wearable device of claim 19, wherein the lighting source has multiple states corresponding to different actions taken by the user, communications received from the one or more emergency contacts, and different emergency alert levels.
